(19) United States
(12) Patent Application Publication
(10) Pub. No.: US 2008/0129816 A1
(43) Pub. Date: Jun. 5, 2008

(54) CHILDCARE VIDEO CONFERENCING SYSTEM AND METHOD

(75) Inventors: Eric W. Mattila, Aurora (CA); Stanley R. Moote, Toronto (CA)

Correspondence Address: CALFEE HALTER & GRISWOLD, LLP, 800 SUPERIOR AVENUE, SUITE 1400, CLEVELAND, OH, 44114, US

(73) Assignee: QUICKWOLF TECHNOLOGY, INC., Aurora (CA)

(21) Appl. No.: 11/565,056

(22) Filed: Nov. 30, 2006

(51) Int. Cl. H04N 7/14

(52) U.S. Cl. 348/14.08; 348/E07.083

(57) ABSTRACT

A child video conference terminal located at a childcare facility and configured for use by a plurality of children to enable the children to video conference with remotely located parties.

### FIELD

Example embodiments described herein relate to communications systems and, in particular, to video conferencing methods and systems.

### BACKGROUND

Children are frequently left by their primary care givers (for example their parents) at group childcare facilities such as daycares where multiple children are under the care of third party childcare workers. Typically, children are physically isolated from their parents at the childcare facility, while the parents tend to other obligations such as work, errands, and the like.

Accordingly, it is desirable to provide a system and method to facilitate communications between children and childcare workers located at a childcare facility and remotely located parties such as parents.

### BRIEF DESCRIPTION OF THE DRAWINGS

Example embodiments will now be described by way of example with reference to the accompanying drawings, through which like reference numerals are used to indicate similar features.

FIG. 1 shows a block diagram of an example of a communications system to which example embodiments can be applied;

FIG. 2 shows a block diagram of a childcare video conference terminal to be used on the communications system shown in FIG. 1;

FIG. 3 shows a diagrammatic view of an example graphical user interface screen of the childcare video conference terminal of FIG. 2;

FIG. 4 shows a diagrammatic view of an example graphical user interface for the childcare video conference terminal of FIG. 2, displaying a menu for initiating a session request with a remote terminal;

FIGS. 5 show a diagrammatic view of a graphical user interface for the childcare video conference terminal of FIG. 2 after a session with a remote terminal has been established;

FIG. 6 shows a diagrammatic view of a graphical user interface on the childcare video conference terminal of FIG. 2 that is displayed when the remote terminal is unavailable;

FIG. 7 is a diagrammatic view of an interface screen for the childcare video conference terminal of FIG. 2, displaying a menu for initiating a session request or initiating a messaging module;

FIG. 8 is a diagrammatic view of an interface screen for the childcare video conference terminal of FIG. 2, displaying a menu for initiating text or audio/video messages;

FIG. 9 is a diagrammatic view of an interface screen for the childcare video conference terminal of FIG. 2, for displaying audio/video messages;

FIG. 10 is a diagrammatic view of an interface screen for the childcare video conference terminal of FIG. 2, for displaying text messages;

FIG. 11 is a diagrammatic view of an interface screen for the childcare video conference terminal of FIG. 2, after the terminal is unlocked by a caregiver or administrator;

FIG. 12 is a diagrammatic view of an interface screen for the childcare video conference terminal of FIG. 2, after the terminal is suspended by a caregiver or administrator;

FIG. 13 is a block diagram of a remote video conference terminal to be used on the communications system shown in FIG. 1;

FIG. 14 is a diagrammatic view of an example login interface screen for the remote video conference terminal of FIG. 13;

FIG. 15 shows a diagrammatic view of an example graphical user interface for the remote video conference terminal of FIG. 13;

FIG. 16 shows a diagrammatic view of a video conference session for the remote video conference terminal of FIG. 13;

FIG. 17 shows a diagrammatic view of an example graphical user interface of an incoming session request screen for the remote video conference terminal of FIG. 13;

FIG. 18 shows a diagrammatic view of an example graphical user interface of a messaging function for the remote video conference terminal of FIG. 13;

FIG. 19 shows a diagrammatic view of an example graphical user interface of a security monitoring function for the remote video conference terminal of FIG. 13;

FIG. 20 shows a diagrammatic view of an example graphical user interface of an administration monitoring function for the remote video conference terminal of FIG. 13;

FIG. 21 shows a block diagram of a conferencing server to be used on the communications system shown in FIG. 1;

FIG. 22 shows a diagram illustrating conference session management according to an example embodiment.

### SUMMARY

According to one example embodiment is a child video conference terminal located at a childcare facility and configured for use by a plurality of children to enable the children to video conference with remotely located parties. The child video conference terminal includes a controller for controlling the operation of the child terminal; a display coupled to the controller; a camera coupled to the controller for capturing a video image of a user of the child terminal during a video conference session; an audio transducer coupled to the controller for capturing audio of a user of the child terminal during a video conference session; an audio output coupled to the controller; a communications interface coupled to the controller for exchanging signals with a communications network during a video conference session; electronic storage accessible by the controller, the storage storing information that includes for each of the plurality of children: (a) unique child identification information; and (b) remote party information identifying at least one remote party that the child is authorized to video conference with; and an input device connected to the controller for receiving from a child ID information for comparison with the child identification information stored on the electronic storage. The controller limits the remote party or remote parties to which a child can initiate a video conference session to the remote party or remote parties that the child is authorized to video conference with.

According to another example embodiment is a video conferencing system for facilitating communications between children at a childcare facility and remote terminals located exterior of the childcare facility. The system includes a child video conference terminal connected to a communications network and configured to permit a plurality of the children at the childcare facility to each video conference with one or more authorized remote terminals, and a remote conference server located external to the childcare facility and in communication with the child terminal and the authorized remote terminals, the conference server tracking usage information for video conference sessions that are established between the child terminal and the remote terminals.

According to another example embodiment is a method of facilitating video conference sessions between at least some children of a childcare facility and remote parties who are exterior of the childcare facility, comprising: providing a child video conference terminal for use by a plurality of children at a childcare facility for video conference sessions; storing at the child terminal information that includes for each child remote party information identifying at least one remote party that the child is authorized to video conference with; receiving through an input device of the video conference terminal child identification information from a child wishing to initiate a video conference session information; and limiting, in dependence on the input child identification information, the remote party or remote parties to which a child can initiate a video conference session to the remote party or remote parties that the child is authorized to video conference with.

### DETAILED DESCRIPTION

The terms “include” and “comprise” are used interchangeably within this document and are non-exhaustive when used, meaning, for example, that elements and items that are identified as including or comprising certain components or features can also include additional components or features that are not expressly identified.

### System Overview

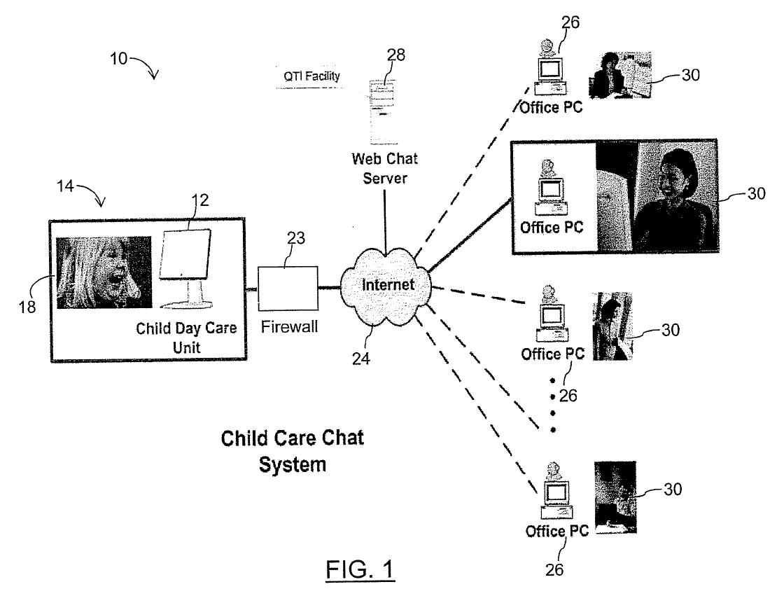

Reference is now made to FIG. 1, which shows a block diagram of a communications system 10 that in example embodiments facilitates 2-way video communication between children in a childcare facility 14, caregivers or administrators within the facility, and other parties, such as family members and friends, who are remotely located relative to the facility. The communications system 10 includes at least one childcare video conference terminal 12 located at a childcare facility 14. One or more childcare video conference terminals 12 may be suitably located in the facility, for example in a central location or in a designated video conferencing room or area. In some example embodiments, for example as illustrated in FIG. 1, only one childcare terminal 12 is required for operation in the childcare facility 14, although additional terminals 12 could also be provided at facility 14. The childcare terminal 12 may have its own processor and may be connected for communication with a wide area network (WAN) 24, which in an example embodiment includes the Internet.

In other example embodiments, multiple childcare terminals 12 are within the childcare facility 14 and are connected to and part of a common intranet, including for example at least one local area network (“LAN”) (not shown). In such embodiments, one of the childcare terminals 12 may be used as a central server in the LAN, or a separate computer could be used as the central server. In some embodiments, one or more childcare terminals 12 may be enabled for wireless communication with the LAN through wireless access points located within the childcare facility 14.

The communication system 10 also includes a number of remote video conference terminals 26 that are exterior of the childcare facility 14 for use by family members or care givers or other concerned parties to video conference with children at the care facility 14. The remote terminals 26 are each connected to the wide area network (WAN) 24. The childcare terminal 12 is also connected, typically through a gateway server and firewall 23 to the WAN 24. In an example embodiment, a conference server 28 is also connected to the WAN 24 to facilitate communications between the remote terminals 26 and the childcare terminals 12 at the care facility 14.

The childcare facility 14 may be any suitable group childcare institution, including for example daycare facilities that may be located in the same office building where the parents or family members would work in, or which may be located in a building that is remote from where the parents/primary caregivers work. If the childcare facility is located in the same building or campus that a primary caregiver works at, the childcare terminal 12 and remote terminals 26 may be connected by way of a local area network (LAN), rather than a WAN 24. In some example embodiments, the childcare facility 14 may even be a private home setting in which a nanny or childcare worker supervises one or more children.

In operation, a child 18, childcare worker, or remote user 30 may wish to request a session between their respective video conference terminals. For example, a child 18 or childcare worker may use a childcare terminal 12, and the remote user 30 may use a remote terminal 26. By way of example, a child 18 may initiate a session request on the childcare video conference terminal 12 with a remote terminal 26. A remote user 30, such as a family member, primary care giver or other authorized concerned party, may use the remote terminal 20 to accept the session request by the childcare terminal 12, resulting in a video conference session being established over the WAN 24 between the childcare video conference terminal 12 and the remote video conference terminal 26. As used herein, the phrase “video conference” includes, among other things, a video communication or conversation session in which audio and video signals are exchanged in real time or near real time between two communications terminals, where one or more persons is participating in the session at each of the terminals.

By way of another example, a remote user 30 may initiate a session request on the remote video conference terminal 26 with the childcare video conference terminal 12. A childcare worker, for example, may then use the childcare video conference terminal 12 to accept the session request from the remote video conference terminal 26, such that a video conference session is established over the WAN 24 between the remote video conference terminal 26 and the childcare video conference terminal 12. By way of yet another example, a video conference session may be similarly initiated by the remote user 30 with a child 18 located at the childcare facility 14.

Note that childcare worker is not limited to persons giving direct care to the children 18. A childcare worker may for example be an administrator, a supervisor, or any employee or volunteer of the childcare facility 14.

In example embodiments, conference server 28 may act as both a connection manager module and directory service module to facilitate network sessions between the video conference terminals 12, 26, to facilitate the customer settings and administration of the network sessions, and to facilitate user registration and billing.

Now that an overview of communications system 10 has been provided, aspects of the system will now be described in greater detail.

### Childcare Terminal

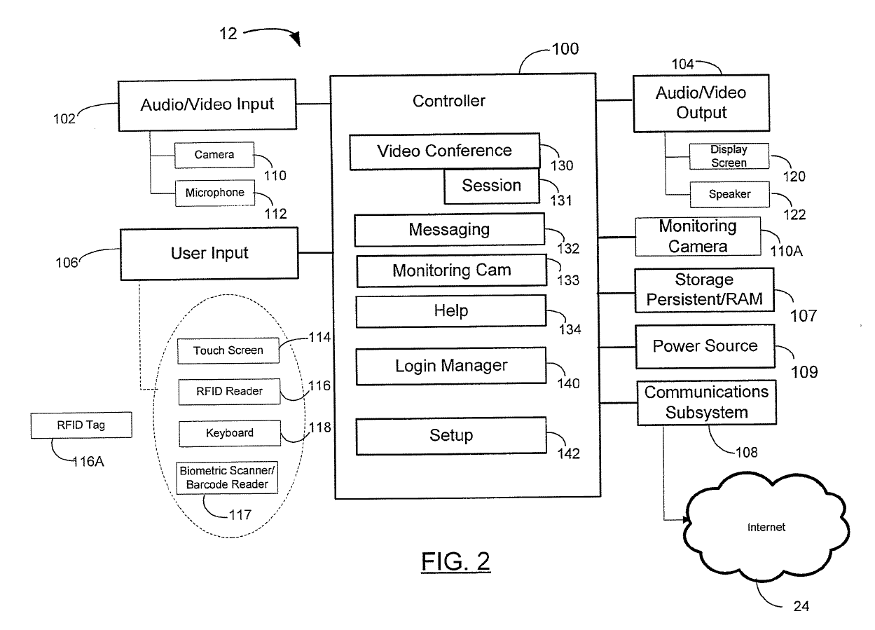

Reference is now made to FIGS. 2 to 12, which show illustrative embodiments of the childcare video conference terminal 12 for use by a child 18 or childcare worker. The childcare terminal 12 is in at least some example embodiments configured to allow a child who is still developing his or her cognitive and physical abilities to initiate and participate in video conference communications with other persons (such as family) at remote terminals 26.

FIG. 2 shows an illustrative block diagram of an example childcare video conference terminal 12 to be used on the communications system 10. As shown in FIG. 2, the childcare video conference terminal 12 has a controller 100 for controlling operation of the childcare video conference terminal 12, an audio/video input 102 and an audio/video output 104 coupled to the controller, a user input 106, and a communications subsystem 108 coupled to the controller 100 for sending and receiving communications information over a network connection to the Internet 24. Terminal 12 also includes electronic storage 107, which is coupled to the controller 100 and can include transient memory such as RAM and one or more persistent storage elements such as, but not limited to, flash memory or a hard drive. The controller 100 can include one or more microprocessors that are coupled to the persistent and/or transient memory of storage 107. Storage 107 stores information and software enabling the microprocessor(s) of controller 100 to implement the childcare terminal functionality described below. In an example embodiment, the childcare terminal 12 includes a power outlet (not shown) or rechargeable power source 109 for providing power to terminal 12.

The audio/video input 102 may be a microphone 112 and camera 110, respectively. The audio/video output 104 may be a speaker 122 and a display screen 120, respectively. As shown, suitable options for the user input 106 may be a touch screen 114, a radio frequency identification (RFID) receiver 116, and/or a keyboard 118. In some example embodiments, a biometric sensor 117 such as a finger print scanner, facial recognition system, or a retinal scanner may be included as or among the user inputs 1 16. In an example embodiment, the keyboard 118 may be removable to prevent misuse or accidental use by children 18 or others.

In an example embodiment, the childcare terminal 12 is implemented using a suitably equipped and configured desktop personal computer. In another example embodiment, the childcare terminal 12 is implemented using a tablet-style computer or laptop computer. The user interface presented by the childcare terminal is in at least some example embodiments configured to be easily used by a child 18 who may still be developing his or her physical functions and cognitive abilities.

Referring again to FIG. 2, there are a number of modules of the controller 100 that may perform desired functions on the childcare video conference terminal 12. In one example embodiment, the modules on controller 100 are implemented by software applications running on a processor of the controller 100, the executable code for such applications being stored on storage 107. As shown, the controller 100 has a video conference module 130, a messaging module 132, a monitoring camera module 133, a help module 134, a login manager module 140, and a setup module 142. The video conference module 130 includes a session module 131. In various embodiments, additional or fewer modules may be implemented by controller 100, and some or all of the functions performed by some modules could be combined into other modules or split into separate modules.

In example embodiments, a child 18 may operate the childcare video conference terminal 12 to initiate or accept video conference sessions with another video conference terminal (including, for example, remote terminal 26) by using the user input 106, which in the illustrated embodiment includes an LCD touch screen 114 which performs the dual role of a display screen 120 and a user input device.

In example embodiments, the terminal 12 is configured for use by a plurality of children 18. For each child 18, the terminal stores or has access to information about one or more remote user care givers (for example parents) that are associated with the child, including information identifying remote terminals associated with the remote user care givers 30.

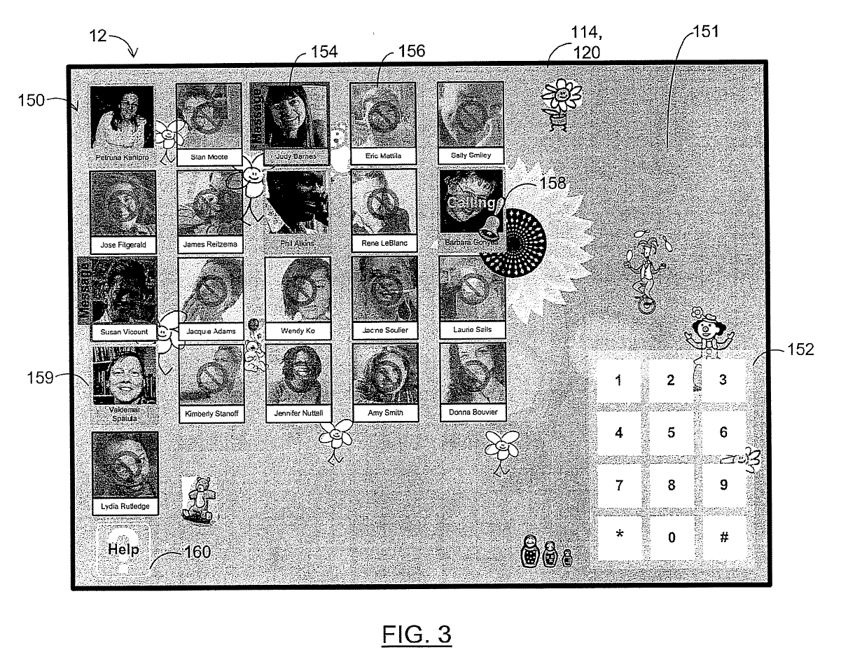

FIG. 3 shows an example of a default home or idle graphical user interface (GUI) 151 rendered on the display screen 120 by controller 100 when the terminal 12 is not engaged in a video conference session or being used for other purposes. In one example embodiment GUI 151 includes a numeric keypad 152 which may be used for logging into the terminal 12 and a help icon 160 for activating the help module 134. In one example embodiment, the childcare terminal 14 is configured such that GUI 151 will include an array of user selectable icons 150, each icon representing a remote user 30 or remote users associated with one or more of the children 18 at childcare facility 14, for example a family member or both parents of a child 18. In an example embodiment, the icon is or includes a thumbnail picture of the associated family member. In some example embodiments, the name of the respective remote user 30 is displayed beneath each icon in the array 150.

In some example embodiments, each icon or thumbnail image 150 in the array may display through the use of color coding, brightness or fading, and overlaid or adjacent symbols or words information related to the state of remote user 30. Icons 154, 156, 158 and 159 illustrate examples of different state information that can be displayed through icons 150. As shown in FIG. 3, icon 154 displays the word “message” when a new unopened message has been received from the remote user “Judy Barnes” 30. Icon 156 is presented in the interface 151 with faded or darker lettering and/or a faded or darker background to provide a visual indication that the remote user “Eric Mattila” associated with icon 156 is not currently available for video conferencing. In some example embodiments, icon 156 has a symbol (such as an Ø, X, etc.) illustrated across the icon to indicate that the remote user 30 is not currently available. In an alternative example embodiment, the icon 156 may not be displayed at all in the interface 151 (i.e., temporarily removed from the interface 151) when it is not an available option. Icon 158 displays the word “calling” to indicate that remote user “Barbara Gonyea” 30 is attempting to initiate a video conference session with terminal 12. In some embodiments, the icon 158 will also flash at the same time. In some embodiments, an audible tone (such as ringing or a bell) may also simultaneously be emitted through speaker 122 when a remote user 30 is calling. In some example embodiments, the audible tone may be configured to be unique to each remote user 30, such that a different audible tone is emitted through speaker 122 when each respective remote user 30 is calling. For example, the audible tone could be a recording or a synthesized voice repeating the phrase: “Chris' mom is calling . . . Chris' mom is calling . . . ” Could be used to announce an incoming call from child Chris' mother. Alternatively, each child may have a favorite song that is used to signal that an incoming call from their parent is being received.

Icon 159 is displayed brightly (non faded) to indicate that the remote user “Valdimir Spatula” 30 is online and available for video conferencing. In some example embodiments, the icon for a remote user 30 that is online and available will be in a different colour than the icon for a remote user 30 that is not available, for example, green and red, respectively. Note that the array of icons 150 may be in any suitable configuration, and is not limited to a row-by-row configuration.

As indicated above, the terminal 12 can be used to both initiate video conference sessions with remote terminals 26 and to answer incoming video conference session requests. The use of the terminal to initiate outgoing video conference requests will now be discussed. In example embodiments, a child or childcare worker who desires to use the terminal 12 is authenticated by or logs in to the terminal 12 by login manager module 140. Such authentication function may be used for example to identify a child user or the childcare worker attempting to use the terminal 12 so that suitable options can be presented to the user. In some example embodiments, the login may be performed using the keypad 152 of GUI 151. Each child 18 may have a unique numeric password configured in the stored in the electronic storage 107 of the childcare video conference terminal 12. The child 18 enters the numeric password onto the keypad 152 using the touch screen 114. If the numeric password matches the password stored in electronic storage 107, the login manager module 140 displays a menu or user interface on the screen 120 that is unique to the identity of the child 18 and corresponds to a respective remote user 30 that is associated with the child 18. The menu that is displayed on the screen 120 will vary depending on the state of the remote user 30, as will be explained in greater detail below. In other example embodiments, an audible message or greeting may be emitted through speaker 122, for example advising the child 18 that a valid password has been entered. In some example embodiments, the audible message may be pre-recorded in the voice of the remote user 30 associated with the child 18, for example a parent's voice, for greeting of the child 18. If the child 18 enters an invalid password onto the numeric pad 152, the login manager module 140 may display the word “invalid password” on the screen 120. In other example embodiments, an audible message may be emitted through speaker 122, for example advising the child 18 that an invalid password has been entered. In some example embodiments, the audible message may be pre-recorded in the voice of the remote user 30 associated with the child 18, for example a parent's voice, indicating that an invalid password has been entered.

In other example embodiments, the child 18 may log into or be authenticated by the terminal 12 by way of a radio frequency identification (RFID) tag 116A. The RFID tag 116A may for example be worn as a bracelet or necklace, or be formed as a conventional passcard. Each child 18 may have an RFID tag (active or passive) configured with a unique identification code, which is also stored in the terminal storage 107. As shown in FIG. 2, the terminal 12 has a corresponding RFID reader 116 for interrogating and/or receiving a signal from RFID tags 11 6A. Accordingly, when a RFID tag 116A is within a predetermined distance of the RFID reader 116, the login manager module 140 will compare ID information received with the RFID tag 116A with the identification stored in the storage 107. If the identification matches, the logging in from the child 18 is accepted by the login manager module 140, and the appropriate menu or user interface may be displayed on the screen 120. In some example embodiments, the RFID reader 116 may be positioned so that when a child 18 points to an icon on the interface 151 having a picture representing a family member using the appropriate arm having the RFID bracelet, the RFID reader 116 detects the RFID bracelet. The RFID tag and RFID reader 116 may alternatively be configured to log in the child 18 when the child 18 is proximate to the video conference terminal 12, for example when the child enters a designated video conferencing room or area in the childcare facility 14.

In other example embodiments, the child 18 may log into the terminal 12 by way of speaking into the microphone 112. The voice characteristics may be compared to voice characteristics of the child 18 stored in the storage 107. If the voice characteristics are suitably matched, then the child 18 will be logged into the terminal 12.

In other example embodiments, biometric data, for example fingerprints, eye retina and iris, and facial patterns may be scanned through biometric sensor 117 and used to identify the identity of the child 18, for logging into the terminal 12.

In other example embodiments, the child 18 may log in by using a barcode reader (not shown) in the terminal 12. The child 18 may have a unique barcode, for example located on a piece of jewelry or badge. The barcode may be compared to the barcode identification of the child 18 stored in the storage 107. If the barcode identification matches, then the child 18 will be logged into the terminal 12.

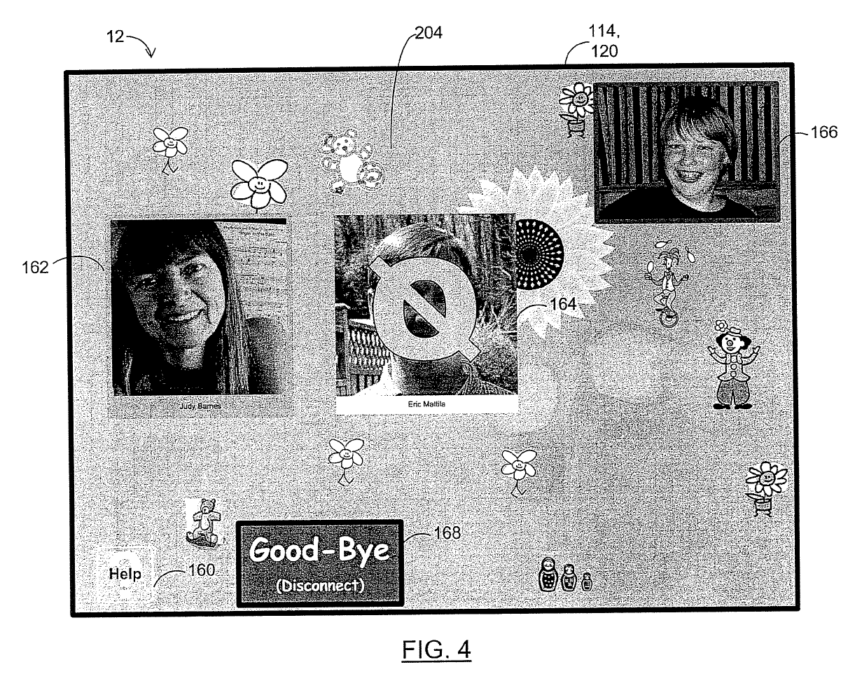

In the illustrated embodiment of FIG. 3, after a child 18 logs into the terminal 12, for example in a manner as described above, the menu on the graphical interface 151 that is thereafter displayed on the screen 120 depends on the state of the remote video conference terminal 26 that is associated with the ID of the child who has logged on. In some example embodiments, the possible menus displayed on the graphical interface 151 are shown in FIGS. 4 to 7.

If at least one of the remote user 30 or users associated with the logged in child is/are online and available for video conferencing, the terminal 12 displays an “initiate session request” user interface 204, for example as shown in FIG. 4. The video conference module 130 performs a video conferencing as follows. In the illustrated embodiment shown in FIG. 4, there is shown calling buttons 162, 164 for two remote users 30 associated with the logged-in child 18. In the illustrated example embodiment of FIG. 4, two parents are associated with the logged in child, namely “Judy Barnes” who is currently on-line and available for video conferencing and “Eric Mattila”, who is not currently available for video conferencing. The “Judy Barnes” button 162 is presented with light lettering (for example green) and bright background to provide a visual indication that selection of the button 162 is available for video conferencing. The “Eric Mattila” button 164 is presented in interface 204 with a symbol (such as an Ø, etc.) illustrated across the icon to indicate that the remote user 30 is not currently available. In some embodiments, the button 164 may be faded or darker lettering and/or a faded or darker background, and may be a different colour (for example red), to provide a visual indication that the button 164 is not currently available for selection. In some example embodiments, more or less than two calling buttons may be used, depending on the number of corresponding remote users 30 associated with the child 18.

Also shown in the illustrated embodiment of FIG. 4 is a child video image 166, which in some embodiments may be a substantially real-time video of the logged-in child 18 using the terminal 12. The source of the video image 166 may for example be obtained by the camera 110. Accordingly, the video image 166 may mirror what is being shown on another video terminal, such as a remote terminal 26. Also shown on the user interface 204 is a good-bye or disconnect button 168 for terminating the video conference session and logging out of the terminal 12 and returning to the default home or idle graphical user interface 151 on the display screen 120 (FIG. 3). In some example embodiments, the terminal 12 may also automatically log out after a set period of inactivity, for example one minute.

Referring again to FIG. 4, the buttons 160, 162, 164, 168 are in example embodiments presented as sufficiently large portions of touch screen 114 that they can easily be seen and pressed by a child 18 using the device, while at the same time minimizing accidental selections. Presenting a child 18 with a limited number of selectable touch screen buttons from the interface screen 204 (FIG. 4) provides an easy to use, relatively error proof interface. Note that other labels could be assigned to the option buttons 160, 162, 164, 168 as appropriate.

As noted above, the terminal 12 will typically be preconfigured to associate each child 18 with one or more corresponding remote user(s) 30. Such pre configuration may occur in a number of ways—for example, the terminal 12 could include a port (for example a UBS port or an Ethernet jack) that allows it to be connected to a configuring device or network, or could include an on-board configuration interface screen. In some embodiments, configuration information can be received from conference server 28 via Internet 24. Configuration or set-up can include for example specifying the on-screen button location and size, and the language to use on the labels for the buttons, loading up pictures to be used in the various interfaces, and associating specific identifying information with calling buttons 162, 164 such that pressing the calling button 162, 164 will initiate a video conference session with the correct remote terminal 26.

With reference to FIG. 4, if a logged-in child 18 wishes to initiate a video conference session with one of the corresponding remote video conference terminals 26 (for example the terminal associated with user “Judy Barnes”), the child 18 selects the “Judy Barnes” button 162 by pressing it on touch screen 114. Once the “Judy Barnes” button 162 has been pressed, the childcare terminal 12 transmits a video conference session request through the WAN 24 for the remote terminal 26 (an example of a session management method for such a session will be discussed further below). Assuming that the remote user at the remote terminal 26 accepts the video conferences request, a video conference session will be established over WAN 24 between the childcare terminal 12 and the remote terminal 26.

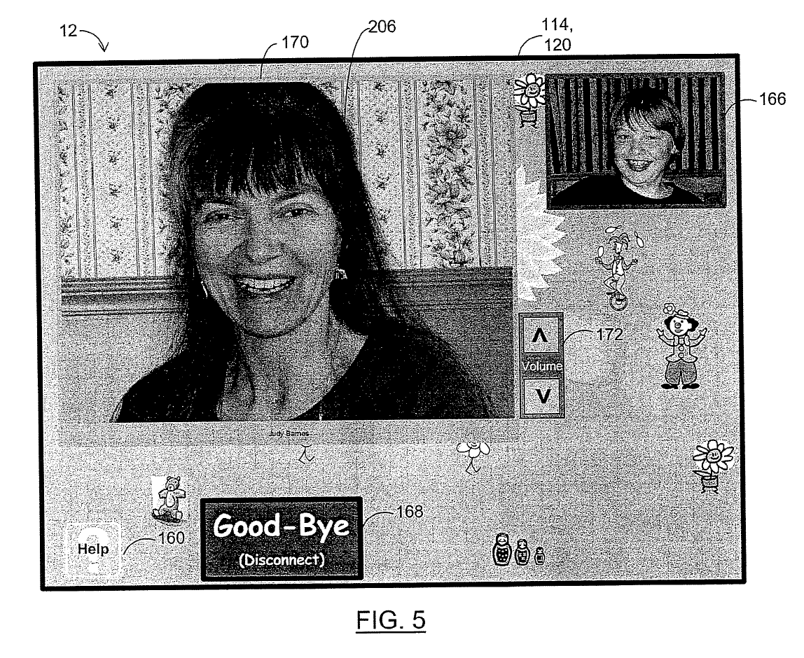

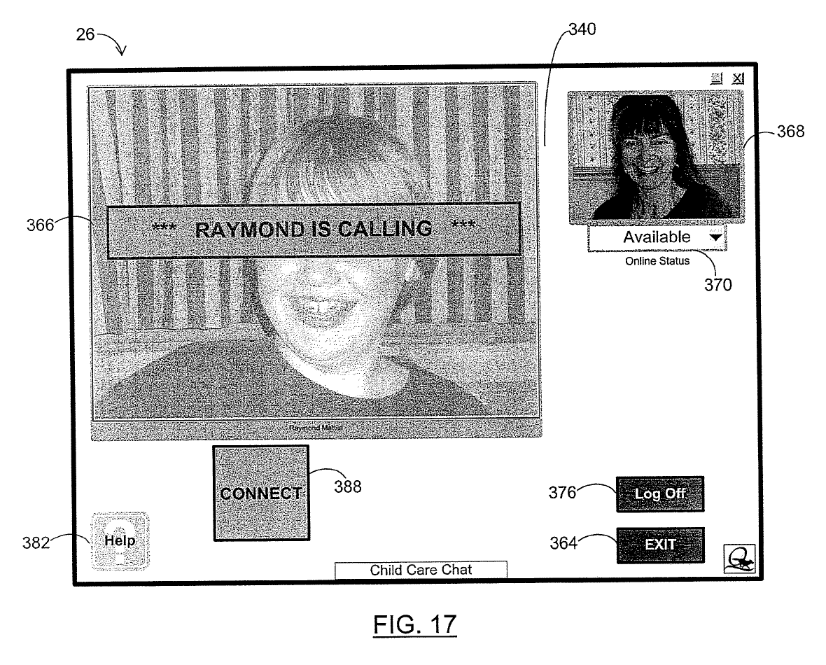

FIG. 5 illustrates an example of a video conference session graphical user interface 206 displayed on screen 114 of the childcare terminal 12 when a video conference session is established between it (through WAN 24) and the remote terminal 26. FIG. 5 shows a main display 170 and volume control buttons 172. During the video conference session, a substantially real time video stream of the remote user 30 will appear in the main display 170 of the childcare terminal display screen 120, and substantially real time audio of the remote user 30 will be output from the speaker 122. A video of the child 18 will be captured by the camera 110 and an audio of the child 18 will be captured by the microphone 112 for sending through the network 24 to the remote terminal 26, enabling an interactive, two-way video conference session to be held. The child can end or terminate the session by pressing the good-bye or disconnect button 168. The volume control buttons 172 may be used by the child 18 to increase or decrease the volume emitted from speaker 122. In some embodiments, upon pressing of the volume control buttons 172, a level indicator (not shown) is momentarily displayed on the screen 120 to indicate the current volume level. The level indicator will disappear from the screen 120 after a set time after the volume adjustment, for example after two seconds. Turning briefly to the remote terminal 26, when an incoming session request is received from a childcare terminal 12, a remote user 30 will then be able to see the session request by way of display screen 320, as shown in FIG. 17. The remote user 30 may accept the session request by selecting the connect icon 388, thereby initiating the network session.

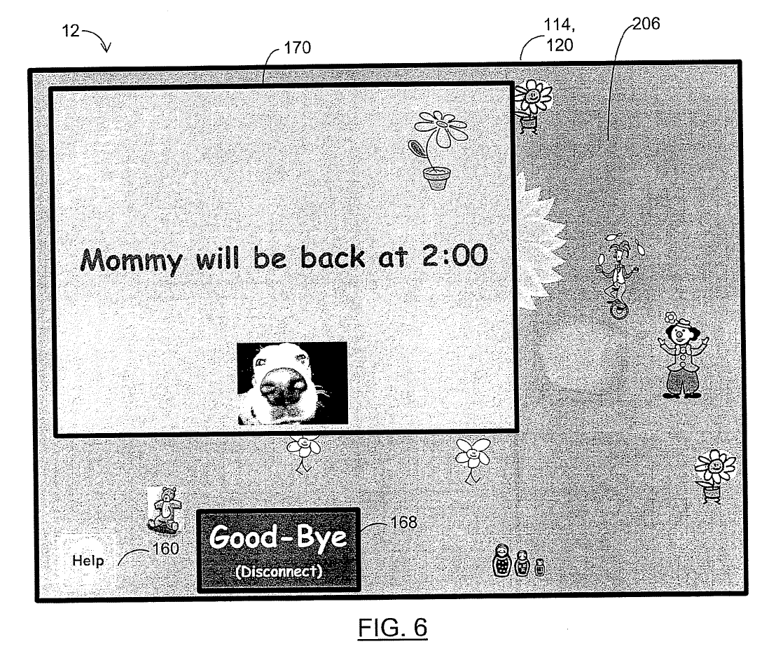

Turning again to FIG. 4, in the event that after a predetermined duration of time the remote user 30 does not respond to the incoming video conference request, or indicates through an input to the remote terminal 26 that he or she does not want to take the call, then a message indicating that the remote user is not available can be displayed on the main display 170, for example “Mommy will be back at 2:00” as illustrated in FIG. 6.

Referring again to FIG. 3, the child 18 may also accept a session request from a remote video conference terminal 26. In an example embodiment, if the corresponding remote user 30 is calling or initiating a network session, this will be shown on the user interface 151, for example as illustrated in the “Barbara Gonyea” icon 158. When a child associated with the remote user represented by the incoming call icon 158 logs into the terminal 12, for example in a manner as described above, the session module 130 automatically accepts the session request, thereby creating a network session. In some example embodiments, child log-on may not be required for accepting an incoming session request—merely selecting the thumbnail icon 158 is enough to accept the incoming call. Once established, the video conference session will be the same as shown in FIG. 5, and previously described.

Referring again to FIG. 3, if the corresponding remote user 30 has set the remote terminal 26 to away or not available, this will be shown on the user interface 151, for example as illustrated in icon 156. When a child corresponding to icon 158 logs into the terminal 12, for example in a manner as described above, the video conference module 130 will display on the main display 170 a message indicating that the remote user 30 is not available, for example “Mommy will be back at 2:00” as illustrated in FIG. 6. The good-bye or disconnect button 168 may be used for logging out of the terminal 12 and returning to the default home or idle graphical user interface 151 (FIG. 3).

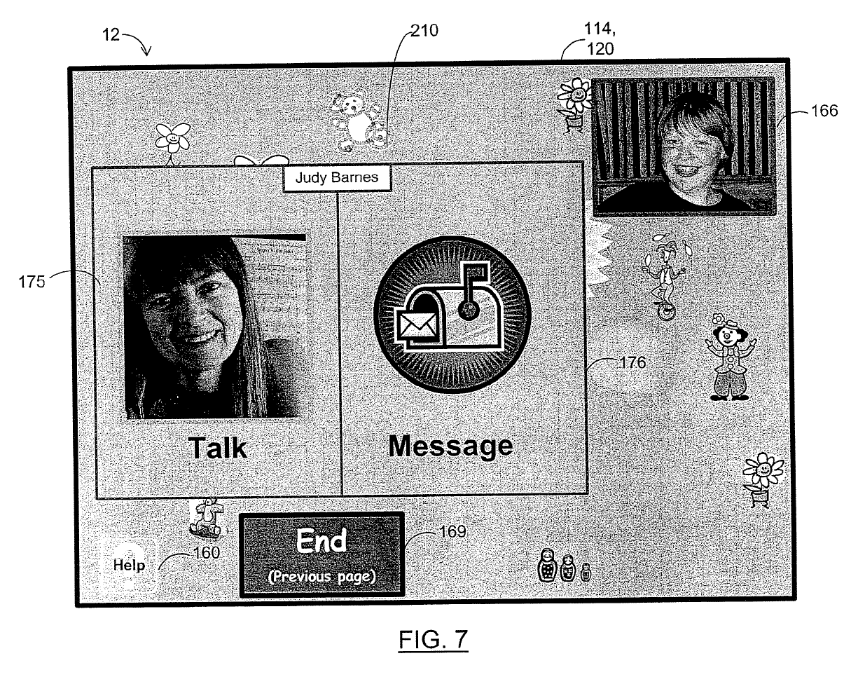

The messaging module 132 will now be explained in greater detail. Referring again to FIG. 3, if a remote user 30 has sent a message from the remote terminal 26 to the childcare terminal 12, this will be shown on the user interface 151, for example as illustrated in icon 154. When a child associated with the remote user that corresponds to icon 158 logs into the terminal 12, for example in a manner as described above, the video conference module 130 will display a menu of user selectable options on the user interface 210, for example as illustrated in FIG. 7. User interface 210 is similar to interface 204, except that in addition to a “talk” button 175 (which includes a thumbnail image of the remote user), the interface 210 also includes a “message” button 176. When the child 18 presses the “talk” button 175, a network session request is initiated to the remote user. In some example embodiments where multiple remote users are associated with a particular child, multiple child selectable “talk” and message buttons can be displayed in interface 210 representing the multiple remote users. In some example embodiments where there are multiple remote users associated with the logged-in child, a single “talk” button may be shown, which when selected links to a further interface such as shown in FIG. 4 that displays the various possible remote users that can be called by the child 18. In some example embodiments, as shown in FIG. 7, the touch screen 114 has an “end” button 169, which will return to the most recently displayed user interface, or will log out of the terminal 12, where applicable. In other embodiments, the childcare terminal 12 will automatically log out after a set period of time, for example after two minutes.

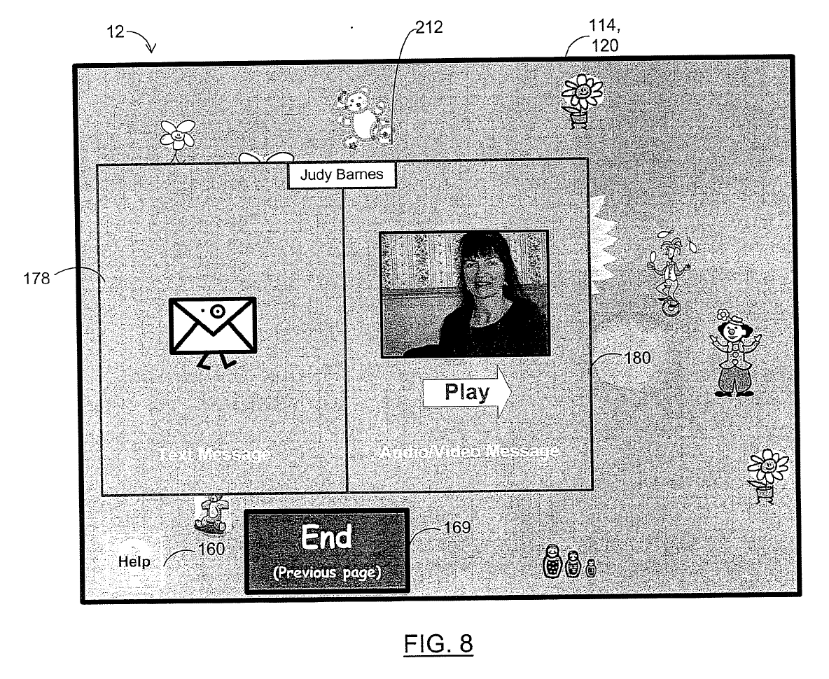

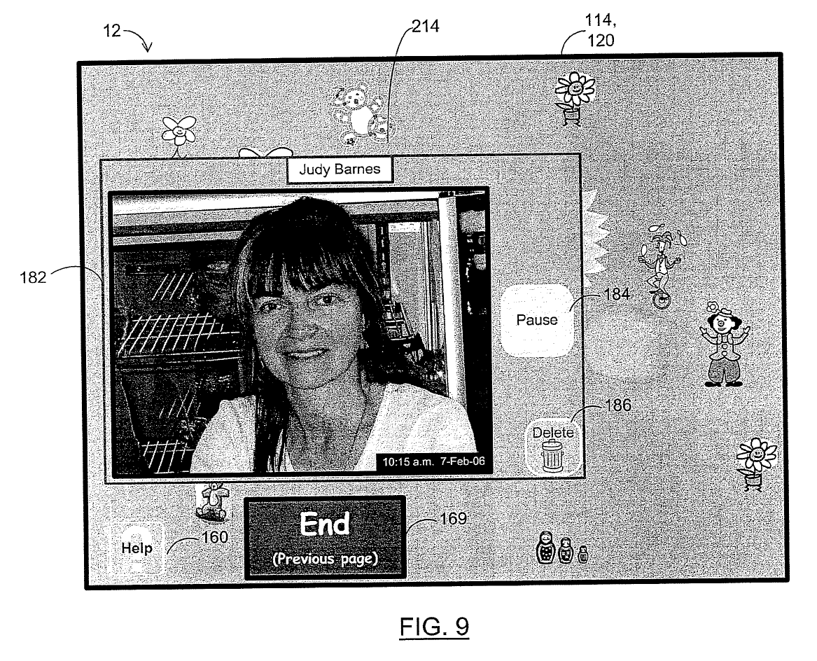

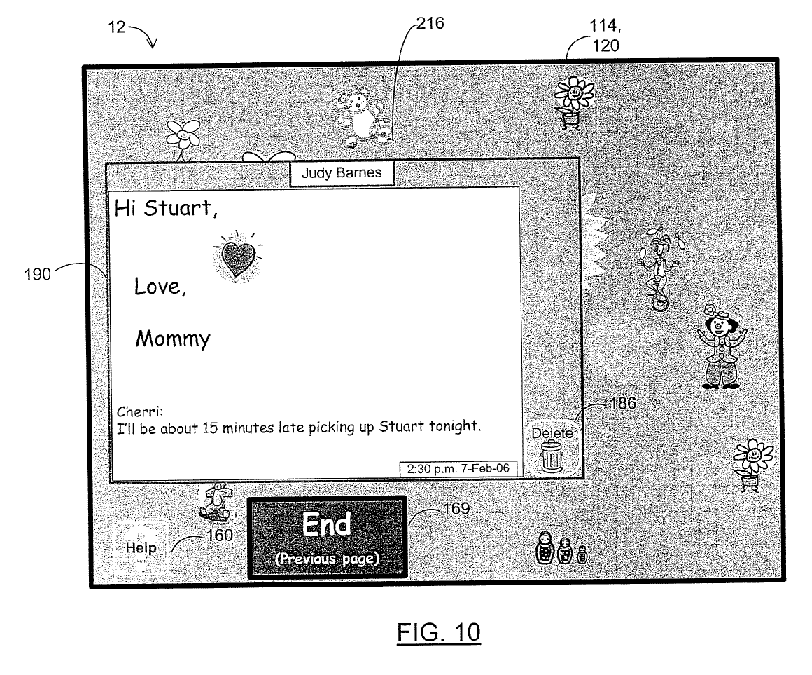

Referring again to FIG. 7, in some exemplary embodiments, the pressing of the “message” button 176 results in a menu being shown on the user interface, for example as illustrated in FIGS. 8 to 10, depending on the state of the corresponding remote user 30. If the remote user 30 has sent both a text message and an audio/video (AV) message, the screen 120 will for example display user interface 212, as illustrated in FIG. 8. FIG. 8 shows the interface 212 having both a text message button 178 and an A/V message button 180. Selection of the text message button 178 results in the display screen 120 displaying the interface shown in FIG. 10, and selection of the A/V message button 180 results in the display screen 120 displaying for example the interface 214, illustrated in FIG. 9. FIG. 9 shows a main display 182 of an A/V message sent by the remote user 30. FIG. 9 also shows a pause button 184 and delete button 186. The A/V message is automatically played upon selecting of the A/V message button 180 (FIG. 7). Upon selecting of the pause button 184, the A/V message pauses, and the pause button 184 is replaced with a play button (not shown). Selecting of the play button once again plays the A/V message. In some embodiments, selecting of the delete button 186 automatically deletes the A/V message and returns to a previous menu, for example interface 210 as illustrated in FIG. 7. In other embodiments, the selecting of the delete button 186 displays a confirmation message, displaying on the interface 214 menu options for the child 18, for example a “yes” button and a “no” button (not shown). If the “yes” button is selected, the A/V message is deleted and the terminal 12 returns to a previous menu, for example as illustrated in FIG. 7. If the “no” button is selected, the A/V message is merely paused and the pause button 184 is replaced with a play button (not shown). If the delete button 186 is not selected, then the A/V message is automatically saved in the storage 107 for future viewing and listening by the child 18. In other embodiments, only an audio message is played on the speaker 122 rather than an audio and video message.

FIG. 10 shows a main display 190 of a text or email message sent by the remote user 30. As noted in FIG. 10, the sent message includes a note to childcare worker “Cherri” advising that the child's parent will be late in picking up the child. In some embodiments, there is a delete button 186 that deletes the text message. In some embodiments, selecting of the delete button 186 automatically deletes the message and returns to a previous menu, for example as illustrated in FIG. 7. In some embodiments, the selecting of the delete button 186 displays a confirmation message, displaying on the interface 212 menu options for the child 18, for example a “yes” button and a “no” button (not shown). If the “yes” button is selected, the text message is deleted and the terminal 12 returns the interface to a previous menu, for example interface 210 as illustrated in FIG. 7. If the “no” button is selected, the text message of FIG. 10 is displayed once again.

In some embodiments, referring again to FIG. 7, if the remote user 30 has sent a text message only (and no A/V message), then the pressing of the “message” button 176 results in the displaying of interface 216 (FIG. 10) only. Similarly, if the remote user 30 has sent an A/V message only (and no text message), then the pressing of the “message” button 176 results in displaying user interface 214 (FIG. 9) only.

Other features of childcare terminal 12 will now be explained in greater detail. Referring again to FIG. 3, selecting of the help icon 160 will activate the help module 134. In some embodiments, selecting of the help icon 160 activates a menu (not shown) on the screen 120 for assisting the child 18. In other embodiments, selecting of the help icon 160 activates a programmed voice emitted from the speaker 122 for assisting of the child 18. In other embodiments, the child 18 may be able to respond to the programmed voice by way of the microphone 112, for responding to the programmed voice or for asking further questions.

The operation of the childcare video conference terminal 12 by the childcare worker will now be explained in greater detail. In some embodiments, referring to FIG. 3, the childcare worker may log in by inputting onto the keypad 152 with the appropriate password. In other embodiments, a keyboard 118 may be temporarily coupled to the terminal 12 for typing in the appropriate password. In other embodiments, the childcare worker may log in by using an RFID tag or by way of speaking into the microphone 112, or through other log-in methods in a similar manner as already explained above in respect of child users.

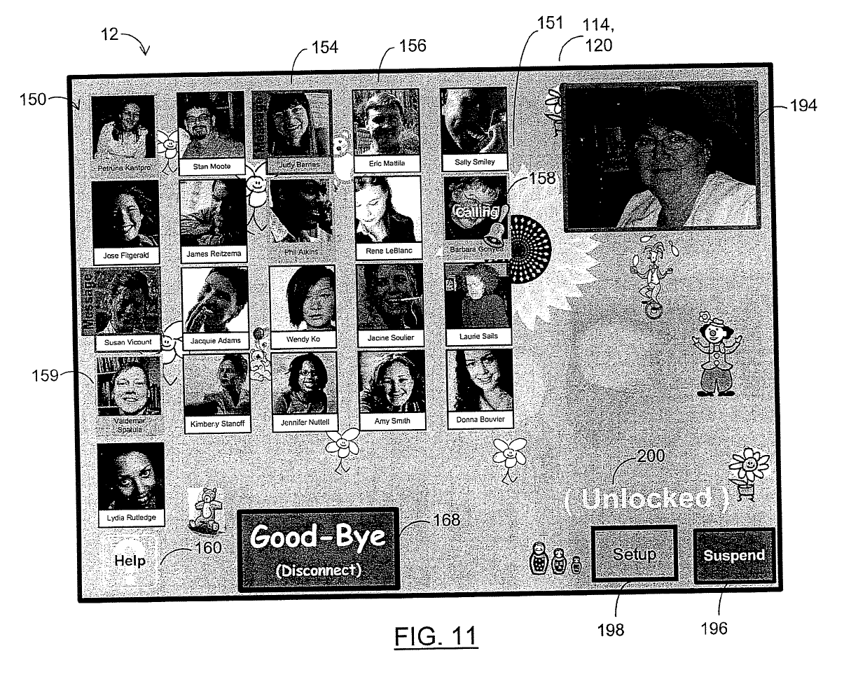

After the logging in by the childcare worker, the terminal 12 displays a menu on the interface 151, for example as shown in FIG. 11. In some embodiments, a status marker 200 indicates “unlocked”, which indicates that the terminal 12 is unlocked for use by the childcare worker. Each of the icons 150 in the array may be selectable by the childcare worker, for example by using the touch screen 118 or key board 118 or other user input device. Referring again to FIG. 11, there is shown a real-time childcare worker image 194 on the interface 151, a setup button 198 and a suspend button 196.

From the menu on the interface 151 (FIG. 11), the childcare worker may select any of the icons 150 in the array. The interface that is thereafter displayed on the screen 120 will vary depending on the state of the remote user 30. If the corresponding remote user 30 or users is online and available for video conferencing, for example as illustrated in icon 159, once such icon is selected the terminal 12 displays an interface similar to interface 204 (FIG. 4). If the corresponding remote user 30 is calling or initiating a session request, for example as illustrated in icon 158, the terminal 12 displays an interface similar to user interface 206 (FIG. 5). Selecting of icon 158 (indicating that the remote user is “calling”) accepts the session request, thereby initiating a network session. As previously described, during a video conference session, a substantially real time video stream of the remote user 30 will appear in the main display 170 of the childcare terminal display screen 120, and substantially real time audio of the remote user 30 will be output from the speaker 122. A video of the childcare worker will be captured by the camera 110 and an audio of the childcare worker will be captured by the microphone 112 for sending through the network 24 to the remote terminal 26, enabling an interactive, two-way video conference session to be held.

If a corresponding remote user 30 is not currently available for video conferencing, for example as illustrated in icon 156, when such an icon is selected the terminal 12 may for example display an away message on user interface 206 (FIG. 6), or may just not display any screen other than interface 151. If the corresponding remote user 30 has a message pending, for example as illustrated in icon 154, upon selection of the icon 154 the terminal 12 may for example display the message menu similar to user interface 210 (FIG. 7).

In at least some example embodiments, the controller 100 implements a setup module 142. The childcare worker may select the setup button 198 in the interface 151 (FIG. 11). The setup module 142 allows the childcare worker to run a setup application to perform various administrative functions to the childcare video conference terminal 12. The setup application may be used to display menus on the interface 151 for network setup and hardware setup. The setup application may also allow a selection of languages for display on the display screen 120, for example English, French, and Spanish.

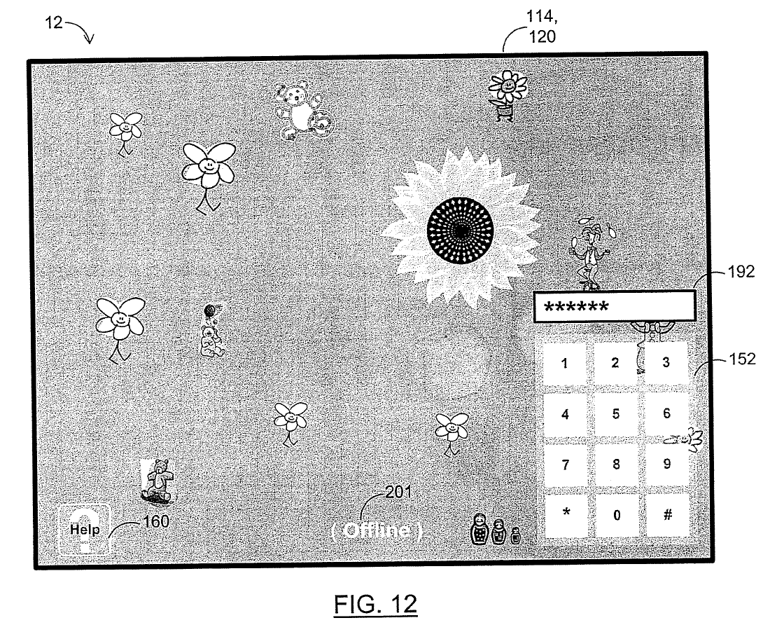

The childcare worker may select the suspend button 196 in the interface 151 (FIG. 11). This results in the terminal 12 showing the interface as shown in FIG. 12. The selection of the suspend button 196 causes the childcare terminal 12 to be in an inactive or unavailable state. In some embodiments, a status marker 200 indicates “offline” when the childcare terminal 12 is in this state. A user, for example a childcare worker may unlock the terminal 12 by inputting the appropriate password in the keypad 152. In some embodiments, a password display 192 may be used to indicate to the user when each password number is entered. In some example embodiments, a “*” is displayed each time a password number is entered.

In some embodiments, the monitoring camera module 133 is provided to enable use of the childcare terminal 12 as a device for remote monitoring of childcare facility 14. In this regard, in one example embodiment, the childcare terminal 12 can be configured such that the camera 110 and/or audio pickup 112 of the terminal 12 can in a one-way monitoring mode of terminal 12, stream near real time video and/or audio from the childcare facility 14 to a remote terminal 26 to allow remote users 30 to monitor the children 18. In some example embodiments, as an alternative to using video conference camera 110 for monitoring, one or more additional monitoring cameras 110A and associated audio microphones are coupled to the childcare terminal 12 through wired or wireless links for providing real-time video feeds to remote terminals 26. The use of additional monitoring cameras 110A allows remote monitoring of facility 14 to continue even when the main video conference camera 110 is being used in a video conference session, and allows the facility 14 to be viewed from a more advantageous location than might otherwise be permitted by main video conference camera 110A. In example embodiments, at any given time a plurality of remote users 30 can login to the system 10 to view a monitoring one-way video feed from one or more monitoring cameras 110A at the childcare facility 14.

In at least some example embodiments, the childcare terminal 12 can be configured as a Voice-over-IP telephone terminal, with a suitable interface being provided through the display screen working on its own or in conjunction with an input device, for example a touch screen.

### Remote Terminals

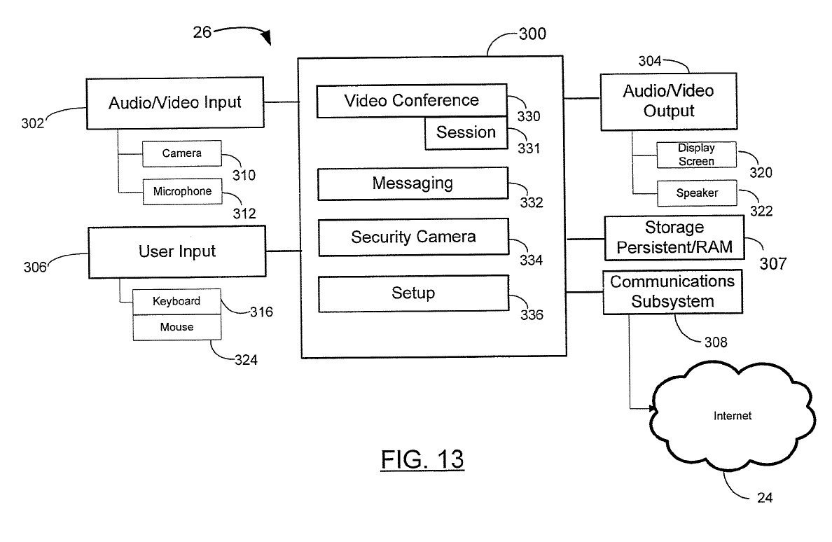

Reference is now made to FIGS. 13 to 21, which show illustrative embodiments of the remote video conference terminal 26 for use by a remote user 30 such as a parent or other primary care giver for example. FIG. 13 shows a block diagram of the remote video conference terminal 26 to be used on the communications system 10. As shown in FIG. 13, the remote video conference terminal 26 has a controller 300 that includes one or more processors for operation of the remote video conference terminal 26, an audio/video input 302 and an audio/video output 304 coupled to the controller, a user input 306, a electronic storage 307 including persistent and RAM storage elements, and a communications subsystem 308 coupled to the controller 300 for sending and receiving communications information over the network (Internet) 24. The audio/video input 302 may be a microphone 312 and camera 310, respectively. The audio/video output 304 may be a speaker 322 and a display screen 320, respectively. In some example embodiments, the microphone 312 and speaker 322 may be in the same physical packaging, for example as a headset. As shown, suitable options for the user input 306 may be (but are not limited to) a keyboard 316 and a mouse 324. The screen 320 could also include touch screen input capability. In example embodiments, the remote terminal 26 can be implemented through a wide variety of electronic devices that are enabled to exchange video and audio data through a wide area network such as the Internet, including for example a suitably configured stationary personal computer, a mobile lap top or other mobile computing device. In some example embodiments, the remote terminal 26 is a mobile wireless communications device such as a suitably configured personal digital assistant (PDA) or cell phone or other processor enabled hand-held or portable device.

Software instructions stored on storage 307 configure the controller to implement modules on the controller 300 to perform desired functions. As shown, the controller 300 has a video conference manager module 330, a messaging module 332, a security camera module 334, and a setup module 336. The video conference module 330 includes a session module 331. In some example embodiments, the functionality of the modules 330-336 could be implemented entirely or partially through an application or applications on a remote, web based server such as server 28, such that little or reduced amounts of software needed to be loaded onto the remote terminal 26. In some embodiments, web-based applications are accessed through a web browser implemented on the device 26.

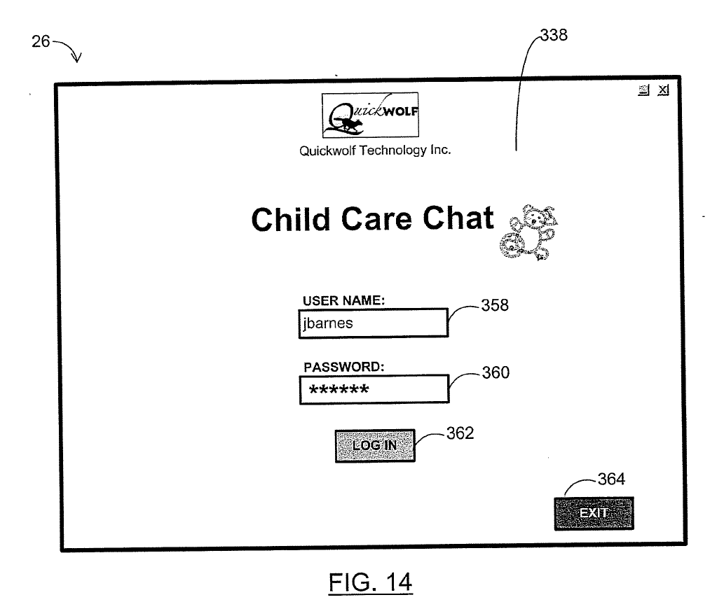

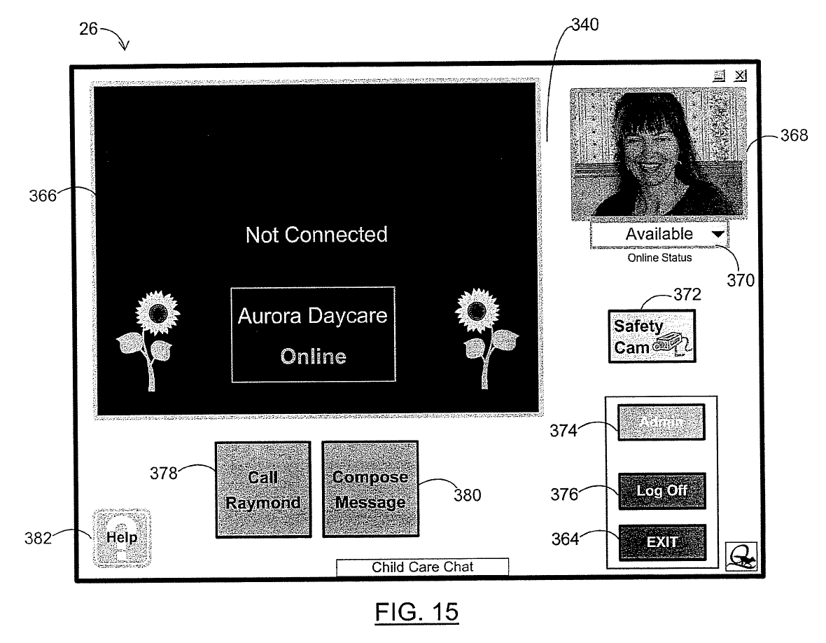

FIG. 14 is an exemplary login interface screen 33 of the remote video conference terminal 26. As shown, there is a user name field 358, a password field 360, a log in icon 362, and an exit icon 364. A user may for example input his or her user name in the user name field 358 and the password in the password field 362. In some example embodiments, the selection of the log in icon 362 will initiate the logging in on the terminal 26. In other example embodiments, a user may for example use keyboard 316 and press “enter” to log into the terminal 26. In some example embodiments, if the password field 362 is left blank and the user presses “enter” on the keyboard 316, the keyboard cursor will be moved to the password field 362 for password entry by the user. Upon logging into the terminal 26, the screen 320 displays the idle or default interface 340 as shown in FIG. 15. In some example embodiments, the selection of the exit icon 364 will end the video conference application and, if applicable, log out the current user.

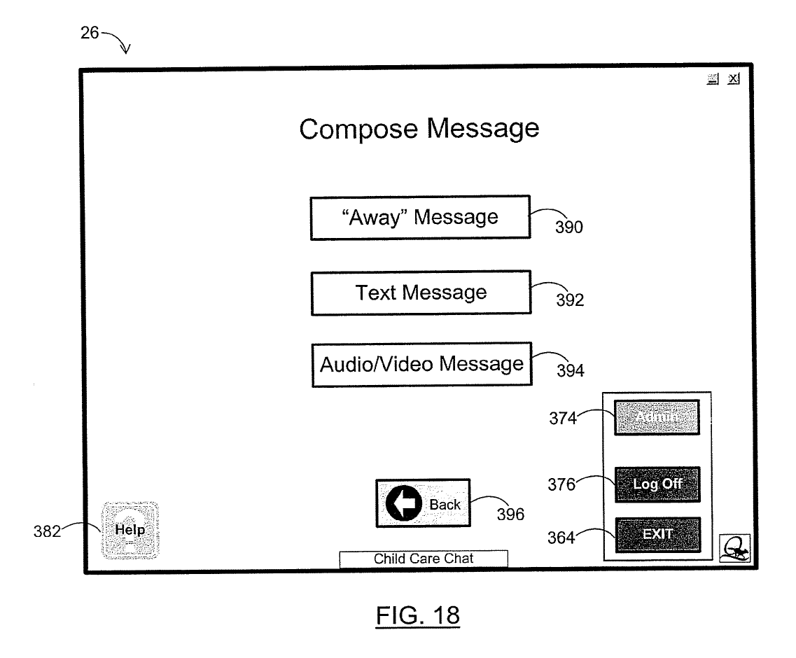

FIG. 15 is an exemplary video conference user interface screen 340 of the remote video conference terminal 26. As shown, there is a main video display area 366, a remote user video display area 368, a status menu 370, a safety cam icon 372, an administration icon 374, a log off icon 376, and an exit icon 364. Also shown is a “call Raymond” icon 378 for initiating a network session with the childcare video conference terminal 12 (Raymond being the son of the party using the illustrated remote terminal 26) and a “compose message” icon 380 for displaying the interface shown in FIG. 18. The main video display 340 may show video images, for example of another party in a video conference session. A video image of the user 30 of the remote terminal 26 is displayed on the remote user video display 368, which mirrors what is displayed on the other video conference terminal. A status menu 370 may be set to “available” or “unavailable”. If the status menu 370 is set to “available”, the remote video conference terminal 26 is available for network sessions. If the status menu 370 is set to “unavailable”, the remote video conference terminal 26 is not available for network sessions and any existing network sessions are ended or terminated.

Referring again to FIG. 15, the remote video conference module 330 can initiate a network session with another video conference terminal, for example a childcare video conference terminal 12. A remote user 30 may use the remote video conference terminal 26 and select the Call Raymond icon 378 using the user input 306. Upon selection, the session module 331 initiates a session request to the specified childcare video conference terminal 12. The child video conference terminal 12 will display a notice that a remote user 30 whom is associated with “Raymond” is calling on the display screen 120. The child 18 or childcare worker may accept the session request, as explained above, thereby initiating the video conference session.

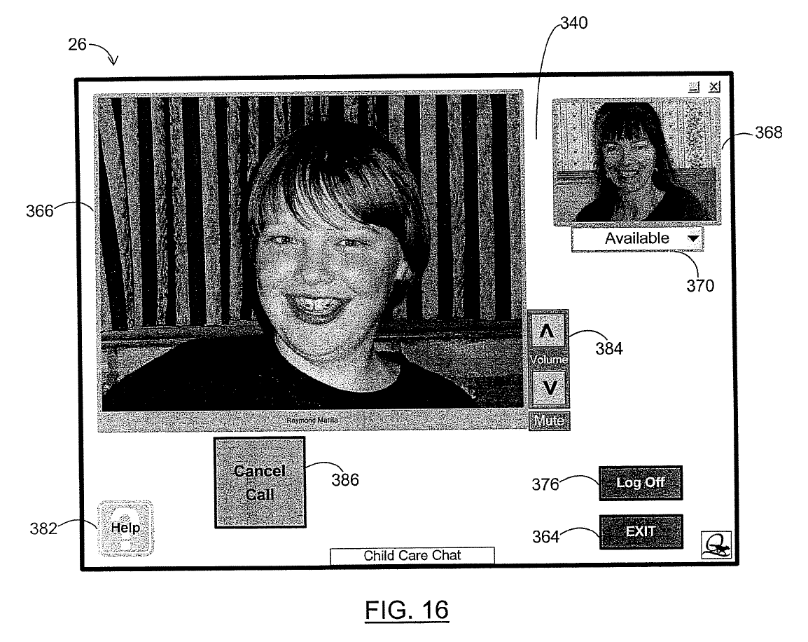

Reference is now made to FIG. 16, which shows an example video conference session. During a video conference session, substantially real-time video of the child 18 (or childcare worker, as the case may be) will appear on the main video display area 366 for the remote user 30 to see, and audio of the child 18 (or childcare worker) will be output from the speaker 322. Similarly, substantially real-time video and audio of the remote user 30 will be captured by the camera 310 and microphone 312, for sending to the childcare video conference terminal 12 by the communications subsystem 308. In some example embodiments, the selection of a cancel call icon 386 will terminate the video conference session. The volume control buttons 384 may be used to increase or decrease the volume emitted from speaker 322. In some embodiments, upon pressing of the volume control buttons 384, a level indicator (not shown) is momentarily displayed on the screen 320 to indicate the current volume level. The level indicator will disappear from the screen 320 after a set time after the volume adjustment, for example after two seconds.

The remote video conference terminal 26 may also accept a session request from another video conference terminal, for example a childcare terminal 12, as shown in FIG. 17. FIG. 17 shows a session request from a childcare video conference terminal 12. A child calling notice is displayed on the main video display screen 366. Upon selection of the connect icon 388, the session request is accepted and a video conference session is established between the remote video conference terminal 26 and the childcare video conference terminal 12.

The other modules of controller 300 will now be explained in greater detail. In at least some example embodiments, the messaging module 332 runs a messaging application as illustrated in FIG. 18. As shown, there is an away message icon 390, a text message icon 392, and an audio/video message icon 394. Selection of the away message icon 390 allows a remote user 30 to compose an away message to be displayed at the childcare terminal 12 (such as is shown in FIG. 6, for example) in response to a session request when the remote video conference terminal 26 is offline. The text message icon 392 allows a remote user 30 to compose a text message for sending to the childcare video conference terminal 12. The audio/video message icon 394 allows a remote user 30 to compose an audio/video message or audio only message for sending to the childcare video conference terminal 12. In some example embodiments, the selection of the “back” icon 396 returns the interface to the previous interface. For example, pressing of the “back” icon 396 will return the interface 342 in FIG. 18 to the idle or default interface 340 (FIG. 15).

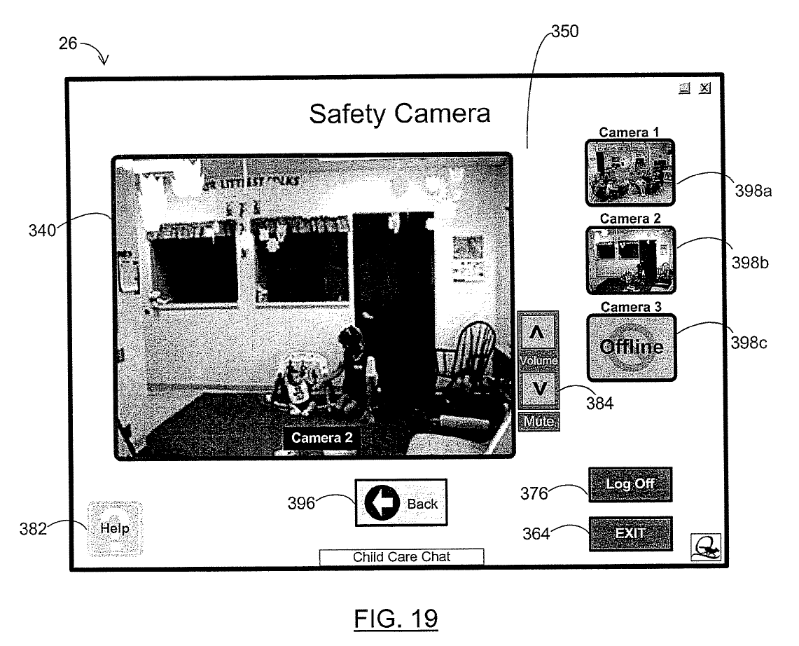

In at least some example embodiments, a security camera module 334 implements a one-way security camera feature when the safety cam icon 372 (FIG. 15) is selected. As shown in FIG. 19, the main video display area 340 displays a one way video feed (and possible audio) from at least one local security camera 110A located in proximity to the child 18. The speaker 322 (FIG. 13) may also output audio corresponding to the video image. Camera thumbnails (398a-c) show smaller video images of other selectable security camera video images available from multiple monitoring cameras 110A that are connected to the childcare facility terminal 12 or another terminal at the facility 14. Upon selection of one of the camera thumbnails (398a-c), the corresponding security camera video image will be shown on the main video display 340. Thus, a remote user 30 can remotely monitor the activities in the childcare facility 14 without initiating a video conference session.

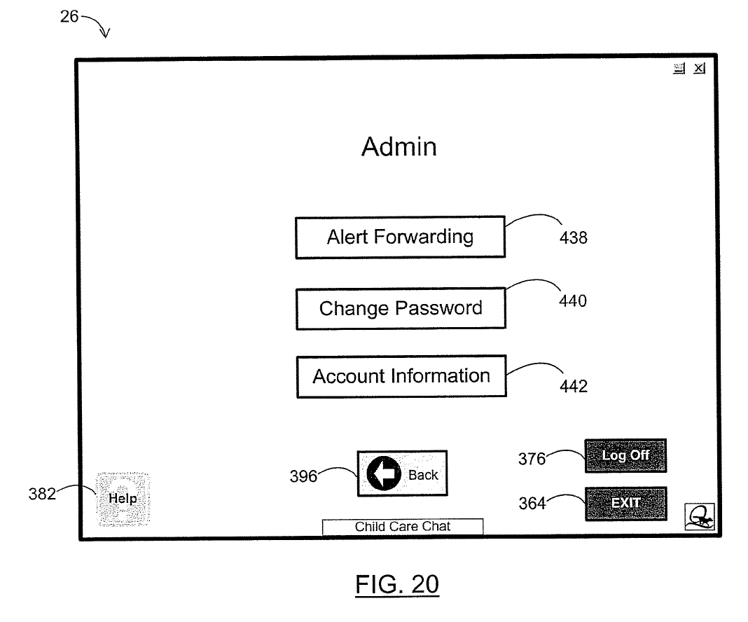

Reference is now made to FIG. 20, which shows an administration interface. In at least some example embodiments, the setup module 336 runs a setup application when the administration icon 358 is selected. As shown, the setup options that may be selected are the alert forwarding icon 438, the change password icon 440, and the account information icon 442. The alert forwarding application sends an email, short message service, or other similar message notifying a remote user 30 of a session request when the remote video conference terminal 26 is unavailable. The password change application permits the remote user 30 to change passwords. The account information application allows the change of account information as necessary.

### Conferencing Server

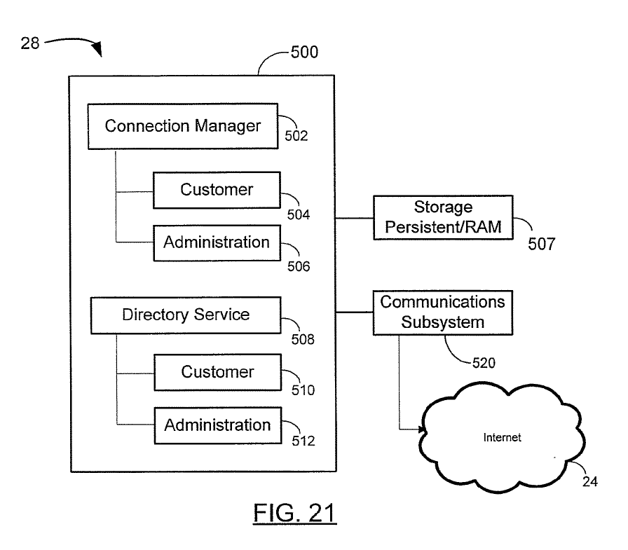

Reference is now made to FIG. 21, which shows a block diagram of a conference server 28 to facilitate communications on the communications system 10. Generally, the conference server 28 may manage accounts and log data relating to video conference sessions carried out using the system 10. The conference server 28 may provide access to software updates, and help for users of the communications system 10. The conferencing server may include a single server or a server cluster. As shown in FIG. 21, the conference server 28 has a controller 500 (implemented by one or more processors) for controlling operation of the conference server 28. Software and data stored on an electronic storage element 507 is used by controller to implement various modules including a connection manager module 502 and a directory service module 508. The connection manager module 502 includes a customer module 504 and an administration module 506. The directory service module 508 includes a customer module 510 and an administration module 512. A communications subsystem 520 is coupled to the controller 300 for sending and receiving communications information over the Internet 24.

The customer module 504 of the connection manager module 502 permits a user to review family and friend online status, find appropriate endpoints by account name, set personal online status, initiate or terminate sessions, manage runtime settings and display items and other operational parameters (for items such as cameras and microphones, favorite links, display preferences), view system alerts (i.e. incoming call attempts), manage the system, and call log.

In at least some example embodiments, the administration module 506 of the connection manager module 502 includes a number of features, permitting an administrator to review online status, review active connections, forced session management (terminate, disconnect, etc), review login and usage statistics for all accounts, and review logs for all accounts.

In at least some example embodiments, the customer module 510 of the directory service module 508 implements a number of features, including history, manage profile, manage account, and help. The history feature maintains a call history with usage metrics, logs the total connection hours, and supports invoicing. The manage profile feature maintains login and account settings, information change, allows a user to change or upload away screens and other graphics, and set customer based limits and thresholds. The manage account feature maintains activation or cancellation of accounts, payment methods, billing methods (per call, bandwidth, etc.), allows viewing of active credits, and account recycling. The help documentation feature maintains frequently asked questions (FAQ), troubleshooting, online instruction manuals, privacy policy, and other agreements.

In at least some example embodiments, the administration module 512 of the directory service module 508 implements a number of features, including customer profile, account information, and current users. The customer profile feature allows viewing of the customer profile (except password and private items), resetting of passwords, and bandwidth restrictions or quality of service. The account information feature allows the change of information as necessary. The current users feature permits viewing of a list of current users logged on.

The conference server 28 may act as a server for several different childcare facilities 14 (and thus several different child care terminals 12) operated by the same or different organizational entities.

### System Operation

Further features of the video conferencing system 10 will now be described. In at least some example embodiments, a service provider will operate the conference server 28 and provide the hardware and software required for childcare terminals 12. The childcare terminals 12 can in various embodiments be purchased or leased by the operators of childcare facility 14 from the service provider, or purchased or leased by the family members of children 18 from the service provider, or may be provided by the service provider on loan to the facility 14 in exchange for the opportunity to entice remote users 30 (typically family members) or others to subscribe to video conference services. In some embodiments, software required to implement the childcare terminal 12 on an existing facility computer or server can be acquired (licensed) from the service provider, for example, through an Internet connection to a store front maintained at conference server 28, or installed from a disc or other software medium. In some embodiments, the entity that operates the conference server 28 can be a different entity than the entity that provides any proprietary hardware and software required for implementing the terminals 12, 26 and server 28.

The software required to implement remote terminals 26 may in example embodiments be licensed for a fee or for free to remote users 30 who subscribe for video conference services, and can be obtained by remote users from the service provider, for example, through an Internet connection to a store front maintained at conference server 28, or installed from a disc or other software medium. In some embodiments, little or no specialised software may be required at remote terminal 26.

The video conference services facilitated through conference server 28 could be made available for various fees to the different participants. For example, the childcare terminal software could be licensed for a fee to the operator or childcare worker of facility 14; remote users could sign up for subscription packages billed monthly, yearly, or based on pay per use, or combinations of the forgoing. In some embodiments, the costs for high speed Internet access to childcare terminals 12 could be paid for by the operators of facility 14, or remote user's, or combinations of the forgoing.

In an example embodiment, when a new user (for example, a family member of a child 18) desires to set up a new account they will access a “New Account” Web page maintained by conference server 28. In an example embodiment, the information collected from the new user while setting up an account can include, among other things: (a) contact information for the new user/subscriber (who may be a family member of a child 18, for example); (b) billing information (Credit Card, pre-payment by cheque, etc.); (c) child information, including Child's name, and possibly a still photo of the child 18; and (d) Family/friends associated with account, i.e. available for video conference sessions with a childcare terminal 12. This information can be made available to the appropriate childcare terminal 12, and any monitoring station terminals 20 that are associated with the childcare terminal 12. There can be several friends and family members (i.e. remote users) listed (and presented) at the childcare terminal 12 as possible parties that video conference sessions can be established with, and for each of the remote users the following information can be collected: (i) Remote user's name (a prompt for a full name for each remote user can be provided as well as a short name or nick name (i.e. “mom”), with the full name being optional for inclusion, and the short name being used for display on the interfaces presented on the childcare terminal 12; (ii) Remote user's email address and/or text message address (optional) (iii) Remote user's still photo (uploaded for example as a JPEG or other graphics file). The photo is passed on to the childcare terminal 12 and used by the childcare terminal 12 as an image combined with the short name on the childcare terminal's touch screen 114, and acts as the thumbnail image used in touch screen control for calling (see FIGS. 3 and 4, for example); (iv) user name; and (v) Password—the conference server 28 can create a default that can be updated through a change password facility.

In one example embodiment, once a terminal 12 has been suitably configured and appropriate accounts opened with the conference server 28, then a terminal can “log in” with the conference server 28 and provide the server with terminal and/or user identification information and any further authentication information that may be required. In at least some example embodiments, remote terminals 26 and childcare terminals 12 that are available for video conference sessions through the Internet 24 with remote terminals 26, will be those terminals that are “logged in” or “on-line” with the conference server 28. In the case of remote terminals 26, the log in procedure could for example be carried out by the video conference module 330 (see FIG. 13). For example, such module may have an associated icon displayed on the display screen 320 of the remote terminal 26—user selection of such icon initiates a video conference application that implements the video conference module 330 on processor 300. Alternatively, the remote terminal 26 could be configured to initiate the video conference application upon start-up of the remote terminal 26. Once logged-in, the video conference module 330 then stays on-line with the video conference server 28 over Internet 24 until the video conference application is shut down or the Internet connection severed, or other predetermined termination event occurs. In some example embodiments, a remote terminal user may alternatively just log-on using a web browser to go to a designated web site hosted by the conference server 28.

In at least some example embodiments, childcare terminals 12 are each configured to log-in to the conference server 28 through the Internet 24 once they are turned on, and to remain logged in so long as a connection exists through the Internet 24 to the conference server 28. In some embodiments, users of terminals 12, 26 can select an “unavailable status”, even when in a logged state, indicating that the user's terminal is unavailable to accept to incoming video conference requests.

The conference server 28 maintains a log of what terminals 12, 26 are currently online, and the availability status of such on-line terminals for accepting incoming video conference requests. The server can be configured to periodically poll the on-line terminals to determine if their status changes, and the terminal scan also be configured to notify the server 28 of any changes in their status (for example if a terminal logs off, or goes from being available to accept incoming session requests to unavailable).

In one example embodiment, a childcare terminal 12 can periodically poll the conference server 28 to track which of the remote terminals 26 that it is associated with (i.e. terminals 26 used by remote users that the childcare terminal 12 is preconfigured to initiate video conference sessions with) are presently logged in to the conference server and available for accepting video conference calls from the childcare terminal 12—using this information, the childcare terminal 12 can then “fade in” or “fade out” thumbnail images (for example, 154, 156, 158, 159 in FIG. 3 and 162, 164 in FIG. 4) depending on the on-line/availability status of the respective remote users. The conferencing server 28 can also be configured to push such status information out to affected childcare terminals 12 when the conference server 28 becomes aware of changes in the status of a remote terminal 26. Similarly, remote terminals 26 can also acquire information from the conference server 28 about the status of their associated childcare terminals 12.

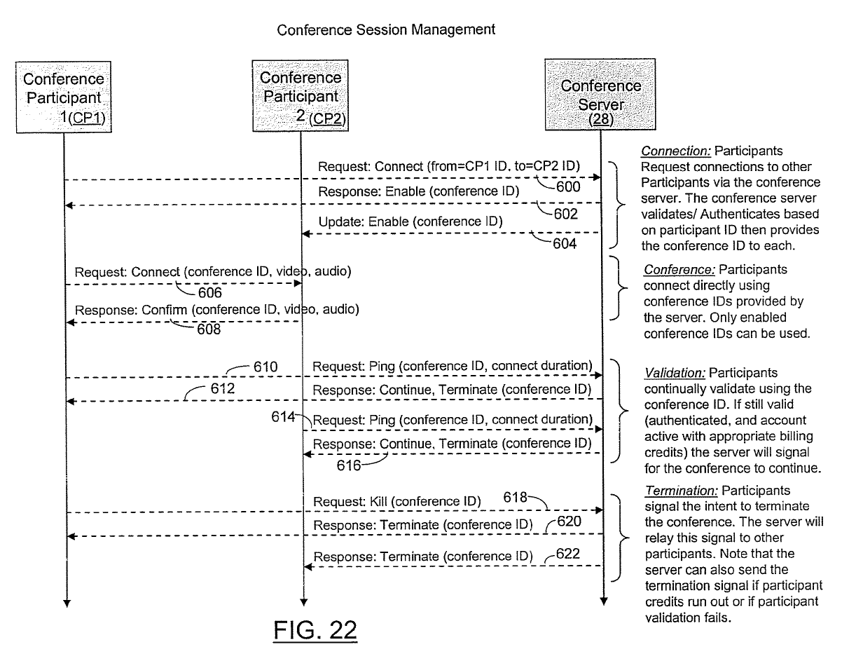

An example conference session between a remote terminal 26 and a childcare terminal 12 will now be discussed with reference to the conference session management messaging diagram of FIG. 22. In the diagram of FIG. 22, for the purpose of the following example conference participant 1 (CP1) represents a childcare terminal 12 and conference participant 2 (CP2) represents a remote terminal 26. When a user of a childcare terminal 12 selects a remote user to call by selecting an on-screen button associated with the remote user (for example, the “Judy Barnes” button 162 of FIG. 4), terminal CP1 sends a connect request message to the conference server 28 (see step 600). The connect request message includes information identifying the sending terminal (CP1 ID) and information identifying the target recipient terminal (CP2 ID). In response to the connect request message, the conference server 28 validates and/or authenticates the two conference participants (for example, the conference server 28 may ensure the terminals CP1 and CP2 are properly logged in, and associated with an active account having appropriate billing credits), and the server 28 then provides a unique conference ID to each of the initiating and target terminals in a conference enable message (steps 602, 604) that is sent to the initiating terminal CP1 in the form of a response message and to the target terminal CP2 as an update message.

Once the conference enable messages have been sent to the participating terminals, the terminals connect directly using the conference It) provided by the conference server 28. In particular, in the example shown in FIG. 22e, after receipt of the conference enable message, the initiating terminal CP1 then sends a connect request message to the target terminal CP2 that includes the conference ID, and the target terminal CP2 then sends a conformation message to the target terminal CP1 that includes the conference ID, thereby establishing a bi-directional video conference session in which video and data are exchanged.

During the video conference session, the participating terminals CP1 and CP2 each periodically validate the ongoing session with the conference server 28 using the conference ID (see steps 610, 612, 614 and 616). So long as the conference server 28 concludes that the conference ID is still valid (the server 28 may for example check to confirm that a time credit is still outstanding on a prepaid account, or that costs or time have not exceeded a predetermined limit), then the server will signal for the ongoing conference session to continue.

Either of the participants can terminate a video conference session by selecting the “End Call” option at their respective terminal. As indicated at step 618, when a participant selects the “End Call” option, the participant's terminal (terminal CP1 in FIG. 26) sends a Kill Request message to the conference server 28 that includes the conference ID. The conference server 28 then sends a terminate session message to each of the participating terminals CP1, CP2, to end the session (steps 618, 620). The conference server 28 can also terminate the video conference session unilaterally by sending the terminate signals to the participating terminals CP1 and CP2, for example if participant credits run out or the ongoing conference validation in steps 610-616 otherwise fails.

The messaging diagram of FIG. 26 has been described above in respect of a video conference session initiated by a childcare terminal 12 with a target remote terminal 26. The diagram would be similar for a video conference session initiated by a remote terminal 26 with a target childcare terminal 12, with the roles of the two terminals being reversed.

It will be appreciated that video conference sessions could be managed by the conferencing server 28 in a manner that is different than what is shown in the example diagram of FIG. 26. In example embodiments in which the conference server 28 participates in the set up, ongoing authorization, and subsequent tear down of video conference sessions, the conference server is able to track for accounting and billing purposes information about the video conference sessions that involve remote terminals 26, including the identity of terminals 12, 26 involved and the duration of the video conference sessions.

In some example embodiments, the conference server 28 can facilitate and track one-way video monitoring sessions in which video from one or more auxiliary cameras 110A is streamed from a child terminal 12 to a remote terminal 26 in much the same way as a two-way video conference session is facilitated. In an example embodiments, a plurality of remote terminals 26 can log-in and watch the monitoring video stream at the same time. In some example embodiments, childcare terminals 12 can be enabled to include a VoIP (Voice Over Internet Protocol) function allowing such terminals to initiate and receive VoIP calls to and from remote terminals 26 and other remote communications devices.

Although the communication system 10 has been described above in the context of childcare facilities, embodiments of the system could also be applied to facilities or organizations having children who wish to communicate with remotely located family members or other parties, including, but not limited to, for example, day schools, boarding schools, and summer camps.

While the invention has been described in detail in the foregoing specification, it will be understood by those skilled in the art that variations may be made without departing from the scope of the invention, being limited only by the appended claims.

What is claimed is:

1. A child video conference terminal located at a childcare facility and configured for use by a plurality of children to enable the children to video conference with remotely located parties, comprising:
a controller for controlling the operation of the child terminal;
a display coupled to the controller;
a camera coupled to the controller for capturing a video image of a user of the child terminal during a video conference session;
an audio transducer coupled to the controller for capturing audio of a user of the child terminal during a video conference session;
an audio output coupled to the controller;
a communications interface coupled to the controller for exchanging signals with a communications network during a video conference session;
electronic storage accessible by the controller, the storage storing information that includes for each of the plurality of children: (a) unique child identification information; and (b) remote party information identifying at least one remote party that the child is authorized to video conference with; and
an input device connected to the controller for receiving from a child ID information for comparison with the child identification information stored on the electronic storage,
the controller limiting the remote party or remote parties to which a child can initiate a video conference session to the remote party or remote parties that the child is authorized to video conference with.

2. The child terminal of claim 1 wherein upon receiving child ID information from the input device, a graphical user interface is rendered on the display that includes, for each remote party that the child inputting the child ID information is authorized to video conference with, a user selectable option that when selected will cause, without further user interaction with the child terminal, the child terminal to send a video conference initiation request over the communications network in respect of the remote party.

3. The child terminal of claim 2 wherein the controller tracks a current availability state of at least some of the remote parties, and wherein the user selectable options are presented in dependence on the current availability state of the remote party or remote parties that the child inputting the child ID information is authorized to video conference with.

4. The child terminal of claim 1 wherein the child terminal stores a unique audio greeting for each of the plurality of children, and the audio greeting unique to a particular child is output through the audio output upon receiving the child ID information for the particular child though the input device.

5. The child terminal of claim 1 wherein the input device includes a RFID (Radio Frequency Identification Device) reader, the terminal further including a plurality of associated RFID tags each assigned to one child and bearing the ID information for that child.

6. The child terminal of claim 1 wherein the input device includes a biometric input device for receiving input of a biometric feature from an ID inputting child.

7. The child terminal of claim 1 wherein the input device includes a barcode reader for reading a barcode presented by an ID inputting child.

8. The child terminal of claim 1 wherein at least some of the remote parties are associated with remote video conference terminals that are identified in the stored remote party information.

9. The child terminal of claim 1 including at least one auxiliary monitoring camera coupled to the controller for enabling remote parties to view video of the childcare facility apart from a video conference session.

10. The child terminal of claim 1 wherein the controller is configured for displaying, at times when no video conference session is currently active, an idle state graphical user interface on the display that includes thumbnail images of at least some the remote parties that the plurality of children are authorized to video conference with, and wherein the child terminal tracks current state information for the at least some remote parties and displays a representation of the current state in association with the thumbnail images.

11. The child terminal of claim 1 wherein the state information includes information as whether a remote party is available or unavailable to video conference with; whether a remote party is currently trying to initiate a video conference session; or whether a remote party has sent a message to the child terminal.

12. The child terminal of claim 1 wherein the controller is configured for receiving a predetermined input from a childcare worker, the controller permitting the childcare worker to initiate a video conference session to any of the remote parties after receiving the predetermined input.

13. A video conferencing system for facilitating communications between children at a childcare facility and remote terminals located exterior of the childcare facility, comprising:
a child video conference terminal connected to a communications network and configured to permit a plurality of the children at the childcare facility to each video conference with one or more authorized remote terminals; and
a remote conference server located external to the childcare facility and in communication with the child terminal and the authorized remote terminals, the conference server tracking usage information for video conference sessions that are established between the child terminal and the remote terminals.

14. The video conference system of claim 13 wherein the conference server is configured for receiving video conference request messages from the child terminal for the remote terminals and providing conference enabling information to the child terminal and the remote terminals in response to the conference request messages.

15. The video conference system of claim 13 wherein the child conference terminal includes at least one monitoring camera for monitoring the childcare facility from which a plurality of the remote terminals can simultaneously receive a video stream.

16. A method of facilitating video conference sessions between at least some children of a childcare facility and remote parties who are exterior of the childcare facility, comprising:
providing a child video conference terminal for use by a plurality of children at a childcare facility for video conference sessions;
storing at the child terminal information that includes for each child remote party information identifying at least one remote party that the child is authorized to video conference with;
receiving through an input device of the video conference terminal child identification information from a child wishing to initiate a video conference session information; and
limiting, in dependence on the input child identification information, the remote party or remote parties to which a child can initiate a video conference session to the remote party or remote parties that the child is authorized to video conference with.

17. The method of claim 16, comprising rendering on a display of the child terminal, after receiving the input child identification information, a graphical user interface that includes, for each currently available remote party that the child inputting the identification information is authorized to video conference with, a user selectable option that when selected will cause, without further user interaction with the child terminal, the child terminal to send a video conference initiation request over a communications network in respect of the remote party.

18. The method of claim 17 including tracking a current availability state of at least some of the remote parties, and wherein the user selectable options are presented in dependence on the current availability state of the remote party or remote parties that the child inputting the child identification information is authorized to video conference with.

19. The method of claim 16 including storing at the child terminal a unique audio greeting for each of the plurality of children, and playing the audio greeting unique to a particular child upon receiving the child identification for the particular child though the input device.

20. The method of claim 16 wherein the input device includes a RFID reader, the method further including providing each of the children with a RFID tag bearing unique ID information for that child.

21. The method of claim 16 wherein the input device includes a biometric input device for receiving input of a biometric feature from a child.

22. The method of claim 16 including displaying on a display of the child terminal, at times when no video conference session is active, a graphical user interface that includes thumbnail images of at least some the remote parties that the plurality of children are authorized to video conference with, and wherein the child terminal tracks current state information for the at least some remote parties and displays a representation of the current state in association with the thumbnail images.
